(19) United States
(12) Patent Application Publication
(10) Pub. No.: US 2011/0271808 A1
(43) Pub. Date: Nov. 10, 2011

(54) HOLD-DOWN DEVICE FOR A PUNCHING DIE AND METHOD FOR PUNCHING OUT AN OPENING OR FOR CUTTING OFF A PLURALITY OF LAYERS OF A CARTON, CORRUGATED BOARD OR THE LIKE

(76) Inventor: Franz Vossen, Stockach-Wahlwies (DE)

(21) Appl. No.: 13/101,699

(22) Filed: May 5, 2011

(30) Foreign Application Priority Data
May 7, 2010 (DE) 10 2010 019 839.0

(51) Int. Cl. B21D 45/08; B26D 7/01

(52) U.S. Cl. 83/27; 83/136

(57) ABSTRACT

A hold-down device (10; 10a) for a punching die (100), wherein the punching die (100) comprises at least one punching or cutting blade (12; 33) which is movable up and down and which serves for punching out an opening (1) or for cutting off a plurality of layers (4 to 6) of a carton, a corrugated board (7) or the like, wherein the punching or cutting blade (12; 33), when interacting with the carton or the corrugated board (7) or the like, compresses the carton or corrugated board (7) or the like, wherein the hold-down device (10; 10a) is arranged at a distance from the at least one punching or cutting blade (12; 33), wherein the hold-down device (10; 10a) is arranged to be movable up and down and wherein the hold-down device (10; 10a), during its downward movement, comes into operative connection with the carton or the corrugated board (7) or the like and moves at least the topmost layer (4) in the direction of the at least one punching or cutting blade (12; 33).

### BACKGROUND OF THE INVENTION

The invention relates to a hold-down device for a punching die and to a method for punching out an opening or for cutting off a plurality of layers of a carton, corrugated board or the like.

When punching out in particular round blanks from corrugated board, carton or the like, there is the problem that the punching blade, before the various material layers are cut through, presses the material layers against one another and the topmost material layer is pulled in the direction of the punching blade in the process, such that high tensile stresses occur in the topmost material layer. Depending on the number of material layers and on the thickness of the material layer, this can lead to uncontrolled tearing of at least the topmost layer before the material layers have been cut through. This is not only visually less satisfactory but can also lead to problems during the punching-out, in particular during the discharge of the punching waste.

The object of the invention is therefore to improve the punching-out of an opening or the cutting-off of a plurality of layers of a carton, corrugated board or the like inasmuch as tensile stresses at least in the topmost material layer of the carton, the corrugated board or the like are avoided or are reduced to such an extent that the stresses possibly remaining do not lead to uncontrolled tearing or breaking of the at least topmost material layer.

### SUMMARY OF THE INVENTION

This object is achieved by means of a hold-down device for a punching die and by a method for punching out an opening or for cutting out a plurality of layers of a carton, corrugated board or the like.

The invention is based on the idea of specifically moving at least the topmost material layer in the direction of the punching or cutting blade, or of feeding said topmost material layer to the punching or cutting blade, by means of a hold-down device which is in contact at least with the topmost material layer, in order thus to reduce or make more uniform the tensile stresses in the topmost material layer.

Advantageous developments of the hold-down device according to the invention for a punching die or of the method according to the invention for punching out an opening or for cutting off a plurality of layers of a carton, corrugated board or the like are specified in the respective dependent claims. All combinations of at least two of the features disclosed in the claims, the description and/or the figures come within the scope of the invention.

In a preferred realization of the invention in terms of design, the hold-down device has a hold-down body which has an elastic contact section which comes into operative connection with the topmost layer of the carton, the corrugated board or the like, and the contact section is inclined by an angle to the horizontal and is arranged in the direction of the carton, the corrugated board or the like and the at least one punching or cutting blade. As a result of the oblique arrangement of the contact section, a force or path component of the contact section in the direction of the punching or cutting blade is achieved during a downward movement of the hold-down body, and this force or path component moves the topmost layer of the carton or the corrugated board in the desired manner in the direction of the punching or cutting blade.

In a further preferred embodiment of the invention which serves for punching out, in particular, round or closed material sections which then accumulate as punching waste, provision is also made for the punching blade to have a closed contour and for the hold-down device to completely surround the punching blade. Owing to the fact that the hold-down device completely surrounds the punching blade, in particular no stress peaks are produced in the material of the cardboard article or of the corrugated board.

Furthermore, it is especially preferred that the hold-down body is designed as a one-piece hold-down body. This permits in particular a relatively cost-effective production and simple handling of the hold-down body, in particular simple fitting and removal.

In the case of complex shapes of the contour to be punched out, it can also be advantageous if the hold-down body is formed from a plurality of segments. In this case, said segments can be formed, for example, by incisions in a continuous strip, such that the contour of the hold-down body can be adapted to the desired punching contour in a simple manner.

Furthermore, it is especially preferred that the contact section of the hold-down body, on the side facing the carton, the corrugated board or the like, projects beyond the cutting edge of the punching or cutting blade when both the punching or cutting blade and the hold-down body are at a distance from the carton, the corrugated board or the like. Such a design has the advantage that, during the downward movement of the punching or cutting blade and of the hold-down body, first of all the hold-down body comes into operative connection with the topmost layer of the cardboard article or the corrugated board and the material for the subsequent punching-out process can therefore be fed to the punching or cutting blade, as it were, in advance.

Furthermore, it is especially preferred that the punching or cutting blade and the hold-down body are arranged on a common supporting body, in particular a supporting plate, which is movable up and down, and in that the hold-down body is arranged on the supporting body in such a way as to be interchangeably fastened by means of retaining pins integrally formed on the hold-down body. By means of such a design, existing punching devices can be retrofitted or upgraded with hold-down devices according to the invention in a simple manner, and therefore the investment costs overall are relatively low.

In addition, in order to permit simple adaptation of the hold-down device to the punching device and simple retrofitting of the hold-down device, it is advantageous if the hold-down device is arranged on the supporting body in an interchangeably fastened manner.

In order to permit the desired motion or force component of the contact section on the topmost layer of the cardboard article or the corrugated board, provision is also made in a preferred embodiment for the elastic section to be formed by an elastic material, in particular an elastic plastic or a rubber material, or by a deformable design of the section of the hold-down body made of a rigid material, preferably metal.

### BRIEF DESCRIPTION OF THE DRAWINGS

Further advantages, features and details of the invention follow from the description below of preferred exemplary embodiments and with reference to the drawings, in which:

FIG. 1 shows a simplified longitudinal section through a punching device having a hold-down device according to the invention for punching out an opening in a cardboard article consisting of corrugated board,

FIG. 2 to FIG. 4 show the stamping device according to FIG. 1 during various phases of the punching operation, likewise in simplified longitudinal sections, and

FIG. 5 shows a simplified plan view through a modified hold-down body for use with a cutting blade spaciously curved longitudinally.

### DETAILED DESCRIPTION

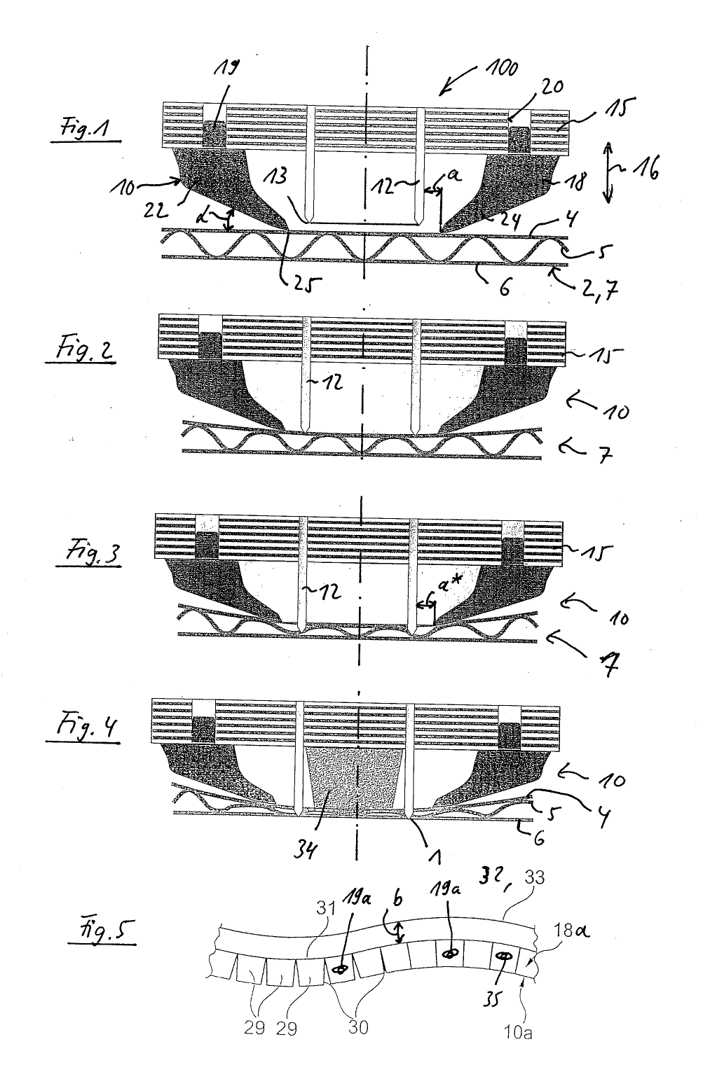

A punching die 100 known per se for punching out an opening 1 in a cardboard article 2 is shown simplified in FIG. 1. In the exemplary embodiment shown, the cardboard article 2 is designed as a corrugated board 7 consisting of three layers 4, 5 and 6. In this case, the one flat layer 4 on the side facing the punching die 100 forms a top layer 4, the central, corrugated layer 5 forms a corrugated layer and the third, likewise flat, layer 6 facing away from the punching die 100 forms a bottom layer 6. A corrugated board having a larger number of layers is of course also conceivable.

In the exemplary embodiment shown, the punching die 100 has a punching blade 12 which is of round design in cross section and which has a circumferential cutting edge 13 on the side facing the corrugated board 7. The punching blade 12 is fastened to a supporting device in the form of a supporting plate 15 and is arranged so as to be movable up and down with the supporting plate 15 in the direction of the double arrow 16. The supporting plate 15 consists in particular of multi-glued plywood and, if need be, is also surface-treated. The punching die 100 interacts with a hold-down device 10 according to the invention.

The hold-down device 10 consists of a hold-down body 18 which, in the exemplary embodiment shown in FIG. 1, is of rotationally symmetrical or substantially sleeve-shaped design. For fastening it to the supporting plate 15, the hold-down body 18 has a plurality of retaining pins 19, for example four retaining pins 19, which are arranged at equal angular distances apart and are integrally formed in one piece on the hold-down body 18. The retaining pins 19 project into holes 20 which are formed in the supporting plate 15 with a slight undersize relative to the size or diameter of the retaining pins 19. In addition, it may be mentioned that, depending on the design of the hold-down body 18, other fastenings of the hold-down body 18 on the supporting plate 15 are also possible and conceivable.

The hold-down body 18 has a section 22 of roughly cylindrical design, adjoining which, on the side opposite the supporting plate 15, is a contact section 24 arranged obliquely at an angle α relative to the horizontal. In this case, the contact section 24 runs toward the punching blade 12, the bottom edge 25 of the contact section 24 projecting beyond the plane of the cutting edge 13 in such a way that, when the punching blade 12 is raised, the (oblique) bottom edge 25 of the contact section 24 is at a smaller distance from the top layer 4 of the corrugated board 7 than the cutting edge 13 of the punching blade 12 with respect to the top layer 4 of the corrugated board 7.

It is also essential that the contact section 24, in particular the bottom edge 25 thereof, is at a radial distance a from the punching blade 12, wherein, in the exemplary embodiment shown, in the case of a punching blade 12 of circular design, the hold-down body 18 is arranged concentrically to the punching blade 12, such that the distance a is the same size overall as viewed over the circumference of the punching blade 12. Depending on the size or diameter of the punching blade 12, the thickness of the corrugated board 7 and the number of layers thereof, the distance a is, for example, between 0.5 mm and 1.5 mm.

The hold-down body 18 is preferably made of an elastic material, in particular of hard rubber or an elastic plastic. Alternatively, it is also possible for the hold-down body 18 to be made of metal or of a combination of plastic and metal, wherein at least the contact section 24 is designed or arranged to be elastic or movable.

The functioning of the punching die 100 and in particular of the hold-down device 10 is explained in more detail below in connection with FIGS. 2 to 4. It can be seen with reference to FIG. 2 that the punching die 100 together with the hold-down device 10 has already been lowered by means of the supporting plate 15 in the direction of the corrugated board 7 to such an extent that the hold-down device 10, with its contact section 24, has already come into contact with the top layer 4 of the corrugated board 7, the contact section 24 being located approximately in the plane of the cutting edge 13 of the punching blade 12.

If the punching die 100 and the hold-down device 10 are now lowered further in the direction of the corrugated board 7 in accordance with FIG. 3, the contact section 24, in particular in the region of the bottom edge 25, travels toward the punching blade 12, the material of the top layer 4 of the corrugated board 7 likewise being moved at the same time onto the punching blade 12 or the cutting edge 13. Therefore the distance of the top layer 4 is shortened between the contact section 24 and the cutting edge 13 of the punching blade 12.

Shown in FIG. 3 is the state in which the punching blade 12 has compressed the layers 4 to 6 of the corrugated board 7 to such an extent that the punching blade 12 has started to cut through the corrugated board 7 and the top layer 4 has already been cut through. Furthermore, it can be seen that the hold-down body 18, when being lowered onto the corrugated board 7, has moved with its contact section 24 in the direction of the punching blade 12, as a result of which the radial distance a* has been reduced relative to the distance a. During the movement of the contact section 24 in the direction of the punching blade 12, the top layer 4 of the corrugated board 7 has at the same time been carried along in the direction of the punching blade 12, such that, although there are higher (tensile) stresses in the top layer 4 than in an unloaded corrugated board 7, these stresses are relatively uniform and in particular locally limited stress peaks do not occur either.

Shown in FIG. 4 is the state in which the punching blade 12 has cut through the layers 4 to 6 of the corrugated board 7. In this case, the punching die 100 can optionally have an ejecting body 34 (only shown in FIG. 4) which is likewise fastened to the supporting plate 15 and which, after the corrugated board 7 has been cut through and after a further downward movement of the punching blade 12, moves the punched-out (central) region 27 of the corrugated board 7 downward by contact with the top side of the corrugated board 7.

Once the punching operation has been completed, the punching die 100 together with the hold-down device 10 is disengaged from the corrugated board 7 by raising the supporting plate 15, the punched-out, central region 27 of the corrugated board 7 remaining as punching waste.

In the exemplary embodiment described up to now, circular punching waste is produced. However, applications in which, for example, closed contours shaped in a different way, or else non-closed contours, are punched in the corrugated board 7 are also possible. Such a contour can also consist, for example, of a combination of a punching section and a grooved section. By way of example according to FIG. 5, a hold-down device 10a can also be used which has a hold-down body 18a which consists of a multiplicity of segments 29 connected to one another. The segments 29 are formed, for example, by a strip-shaped body in which incisions 30 are formed which extend up close to a base 31. The base 31 forms a closed contour which is arranged at a distance b from the cutting edge 32 of a cutting blade 33. Here, too, at least some of the segments 29 have retaining pins 19a which are arranged, for example, in elongated holes 35 of a supporting plate (otherwise not shown).

The hold-down device 10, 10a described up to now can be altered or modified in a variety of ways without deviating from the inventive idea. The inventive idea consists in moving, by means of the hold-down device 10, 10a material of a top layer 4 of a cardboard article 2, consisting in particular of corrugated board 7, in the direction of a punching blade 12 or cutting blade 33 during the punching in order thus to avoid stress peaks in the top layer 4 of the corrugated board 7, which otherwise leads to uncontrolled tearing of the cardboard article 2 or of the corrugated board 7. The invention can also be applied in the case of cartons which have a multiplicity of layers connected to one another in a planar manner.

1. Hold-down device (10; 10a) for a punching die (100), wherein the punching die (100) comprises at least one punching or cutting blade (12; 33) which is movable up and down and which serves for punching out an opening (1) or for cutting off a plurality of layers (4 to 6) of a carton or a corrugated board (7), wherein the punching or cutting blade (12; 33), when interacting with the carton or the corrugated board (7), compresses said carton or corrugated board (7), wherein the hold-down device (10; 10a) is arranged at a distance (a; b) from the at least one punching or cutting blade (12; 33), wherein the hold-down device (10; 10a) is arranged to be movable up and down and wherein the hold-down device (10; 10a), during its downward movement, comes into operative connection with the carton or the corrugated board (7) and moves at least the topmost layer (4) in the direction of the at least one punching or cutting blade (12; 33).

2. Hold-down device according to claim 1, wherein said hold-down device has a hold-down body (18; 18a) which has an elastic contact section (24) which comes into operative connection with the topmost layer (4) of the carton or the corrugated board (7), and in that the contact section (24) is inclined by an angle (α) to the horizontal and is arranged in the direction of the carton or the corrugated board (7) and the at least one punching or cutting blade (12; 33).

3. Hold-down device according to claim 2, wherein the punching blade (12) has a closed contour, and in that the hold-down device (10) completely surrounds the punching blade (12).

4. Hold-down device according to claim 2, wherein the hold-down body (18; 18a) is designed as a one-piece hold-down body (18; 18a).

5. Hold-down device according to claim 2, wherein the hold-down body (18a) is formed from a plurality of segments (29).

6. Hold-down device according to claim 4, wherein the contact section (24) of the hold-down body (18) has a closed contour.

7. Hold-down device according to claim 2, wherein the contact section (24) of the hold-down body (18; 18a), on the side facing the carton or the corrugated board (7), projects beyond the cutting edge (13) of the punching or cutting blade (12; 33) when both the punching or cutting blade (12; 33) and the hold-down body (18; 18a) are at a distance from the carton or the corrugated board (7).

8. Hold-down device according to claim 2, wherein the punching or cutting blade (12; 33) and the hold-down body (18; 18a) are arranged on a common supporting body (15) which is movable up and down, and in that the hold-down body (18; 18a) is arranged on the supporting body (15) in such a way as to be interchangeably fastened by means of retaining pins (19; 19a) integrally formed on the hold-down body.

9. Hold-down device according to claim 8, wherein the contact section (24) is formed by an elastic material or by a deformable design of a section of the hold-down body (18; 18a) made of a rigid material.

10. Method for punching out an opening (1) or for cutting off a plurality of layers (4 to 6) of a carton or a corrugated board (7) in which at least one punching or cutting blade (12; 33) which is movable up and down cuts through the layers (4 to 6), the carton or the corrugated board (7) during the downward movement, characterized in that the punching or cutting blade (12; 33) interacts with a hold-down device (10; 10a) which is movable up and down and which, during its downward movement, with a contact section (24), comes into operative connection with the carton or the corrugated board (7) and moves the carton or the corrugated board (7) in the direction of the punching or cutting blade (12; 33).

11. Method according to claim 10, wherein the contact section (24) of the hold-down device (10; 10a) comes into operative connection with the carton or the corrugated board (7) before the punching or cutting blade (12; 33).

12. Method according to claim 11, wherein the hold-down device (10; 10a), during its downward movement, is deformed by the carton or the corrugated board (7).

13. Method according to claim 12, wherein the punching blade (12; 33) and the hold-down device (10; 10a) are moved synchronously.
